(19) United States
(12) Patent Application Publication
(10) Pub. No.: US 2001/0045918 A1
(43) Pub. Date: Nov. 29, 2001

(54) DISPLAY APPARATUS HAVING CONVERTING DEVICE FOR CONVERTING IMAGE SIGNAL

(76) Inventors: YOSHIHIRO USHIGUSA, TSURUGASHIMA-SHI (JP); SHINICHI ISHIZUKA, TSURUGASHIMA-SHI (JP); NOBORU MINAGAWA, TSURUGASHIMA-SHI (JP)

Correspondence Address: RICHARD P BERG, LADAS & PARRY, 5670 WILSHIRE BLVD, SUITE #2100, LOS ANGELES, CA, 900365679

(21) Appl. No.: 09/111,630

(22) Filed: Jul. 7, 1998

(30) Foreign Application Priority Data
Jul. 8, 1997 (JP) P09-182524

(51) Int. Cl. G09G 5/00

(52) U.S. Cl. 345/5

(57) ABSTRACT

A display apparatus having: an inputting device for inputting a first image signal generated for a first display device having a first coloring characteristic defined by a first color range shown in a chromaticity diagram; a converting device for converting the inputted first image signal into a second image signal for a second display device having a second coloring characteristic defined by a second color range shown in the chromaticity diagram, the second color range and the first color range are different from each other; a driving device for generating a driving signal on the basis of said second image signal; and the second display device for displaying an image on the basis of the driving signal.

### BACKGROUND OF THE INVENTION

1. Field of the Invention

The present invention relates to a display apparatus for displaying an image on the basis of an image signal including a color signal to indicate respective primary colors of a red (hereafter, referred to as R), a green (hereafter, referred to as G) and a blue (hereafter, referred to as B).

2. Description of the Related Art

There is a CRT (Cathode Ray Tube) display which uses a so-called Braun tube, as the most typical display apparatus which can display a color image. This CRT excites fluorescent materials corresponding to the above mentioned R, G and B, which are the three primary colors of light, by electrons accelerated on the basis of an image signal to be displayed and then causes the fluorescent materials to emit light to thereby display the color image.

There is a chromaticity diagram representing hue and saturation (chroma) except luminance among the three elements of color on a coordinate. The chromaticity diagram is utilized for representing conditions or characteristics of color in the display operation of a CRT. This chromaticity diagram is standardized by an International Commission on Illumination (CIE). By plotting the X and Y chromaticity coordinates of the R, G and B on the chromaticity diagram, a triangle (hereinafter, it is referred to as a chromaticity triangle) is formed on the chromaticity diagram. The vertexes of the chromaticity triangle correspond to the chromaticity coordinates of the R, G and B, respectively. The chromaticity triangle represents a color range of a CRT.

On one hand, there is an EL (Electro-Luminescence) display as another display apparatus in which a color display is possible. This EL display has been largely researched in recent years since it can realize a small flat display.

The coloring characteristics of the materials which generate the respective colors corresponding to the three primary colors of light are different in a case of comparing the CRT with the electroluminescence element (that is, the colors of the actually displayed images are different between the CRT display and the EL display when the same image signal is inputted). Thus, the forms of the respective chromaticity triangles on the chromaticity diagram are different from each other.

Hence, for example, if a so-called NTSC (National Television System Committee) signal generated for the CRT is used to drive the EL display, a color appeared on the EL display is different from a color appeared on the CRT, due to the different forms of the chromaticity triangles. As a result, a so-called color difference occurs, and therefore, reproducibility of color is reduced. That is, if the same NTSC signal is inputted to the CRT display and the EL display, a color condition of an image displayed on the EL display is different from that displayed on the CRT display. Accordingly, the reproducibility of the color is reduced as compared with the color of an original image, when the image is displayed on the EL display.

### SUMMARY OF THE INVENTION

It is therefore an object of the present invention to provide a display apparatus which can reduce as much as possible the color difference to thereby improve the color reproducibility, even if an image signal generated for a certain display apparatus is used to drive another display apparatus whose coloring characteristic is different from the certain display apparatus.

According to the present invention, the above mentioned object can be achieved by a display apparatus having: an inputting device for inputting a first image signal generated for a first display device having a first coloring characteristic defined by a first color range shown in a chromaticity diagram; a converting device for converting the inputted first image signal into a second image signal for a second display device having a second coloring characteristic defined by a second color range shown in the chromaticity diagram, the second color range and the first color range are different from each other; a driving device for generating a driving signal on the basis of the second image signal; and the second display device for displaying an image on the basis of the driving signal.

Namely, the first image signal is generated in order to display an image on the first display device. The converting device converts the first image signal is converted into the second image signal suitable for the second display device. Accordingly, it is possible to reduce the color difference, and improve the color reproducibility.

Furthermore, the converting device may convert the inputted first image signal into the second image signal by changing luminance of a red color generated by a red signal included in the first image signal, luminance of a green color generated by a green signal included in the first image signal, and luminance of a blue color generated by a blue signal included in the first image signal. Thus, it is possible to generate the second image signal without complex processes.

Moreover, the converting device may convert the inputted first image signal into the second image signal by performing a chromaticity coordinates transformation in the chromaticity diagram. Thus, it is possible to generate the second image signal without complex processes.

Moreover, the converting device may convert the inputted first image signal into the second image signal by using pre-set matrix data. Thus, it is possible to generate the second image signal without complex processes.

Moreover, when a particular color generated by the inputted first image signal has chromaticity coordinates defining a point located inside the first color range and located outside the second color range, the converting device may convert the inputted first image signal into the second image signal so as to generate an analogous color having chromaticity coordinates defining a point located inside the second color range and located at a closest position to the point defined by the chromaticity coordinates of the particular color. Accordingly, the color difference can be reduced as much as possible, when a particular color is displayed on the second display device.

The nature, utility, and further feature of this invention will be more clearly apparent from the following detailed description with respect to preferred embodiments of the invention when read in conjunction with the accompanying drawings briefly described below.

### BRIEF DESCRIPTION OF THE DRAWINGS

FIG. 1 is a block diagram showing a construction of a display apparatus of an embodiment of the present invention; and

FIG. 2 is a chromaticity diagram showing a difference between a chromaticity triangle of a CRT display and that of an organic EL display.

### DETAILED DESCRIPTION OF THE PREFERRED EMBODIMENTS

Referring to the accompanying drawings, embodiments of the present invention will be now explained. In the description set forth herein, the present invention is embodied in a display apparatus capable of driving an organic EL display panel by using an NTSC signal generated for a CRT.

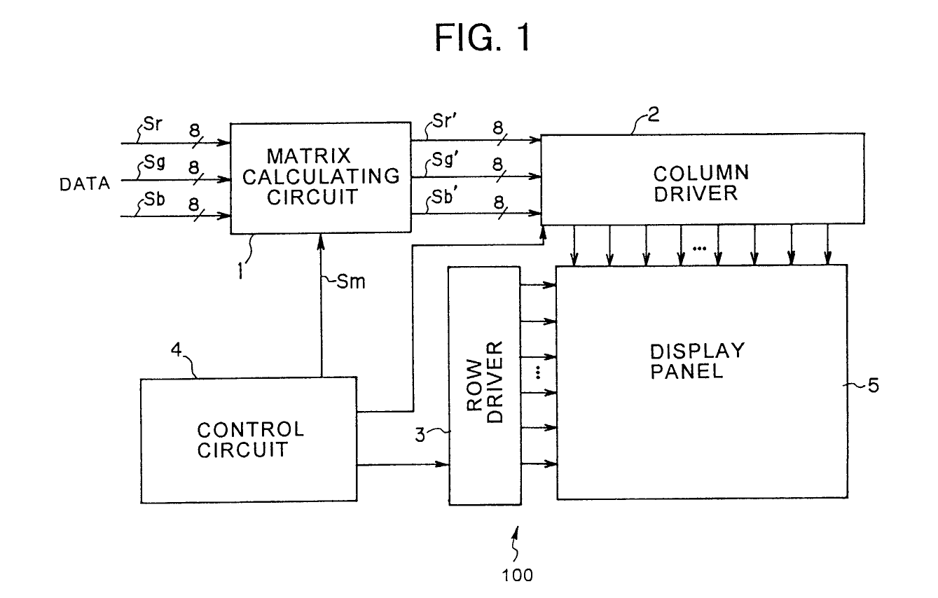

At first, a configuration of the display apparatus in the embodiment is explained with reference to FIG. 1.

As shown in FIG. 1, a display apparatus 100 in the embodiment is provided with a matrix calculating circuit 1, a display panel 5, a column driver 2, a row driver 3 and a control circuit 4. At this time, the display panel 5 is an organic EL display, and has a plurality of column electrodes arranged parallel to a column direction (a longitudinal direction in FIG. 1) and a plurality of row electrodes arranged parallel to a row direction (a lateral direction in FIG. 1). Then, an image to be displayed on the display panel 5 is generated such that a point at which the column electrode and the row electrode cross each other becomes a pixel.

In the operation of the display apparatus 100, a data red signal Sr (a color signal indicative of a red in an original NTSC signal), a data green signal Sg (a color signal indicative of a green in the original NTSC signal) and a data blue signal Sb (a color signal indicative of a blue in the original NTSC signal), which are generated by analyzing an NTSC signal inputted from an exterior for each color, are inputted to the matrix calculating circuit 1. Then, a later described chromaticity coordinate transformation on the chromaticity diagram is performed by using a matrix coefficient included in a matrix coefficient signal Sm from the control circuit 4 by the matrix calculating circuit 1. Accordingly, a converted red signal Sr′ (corresponding to the data red signal Sr before the conversion), a converted green signal Sg′ (corresponding to the data green signal Sg before the conversion) and a converted blue signal Sb′ (corresponding to the data blue signal Sb before the conversion) are generated. Then, the converted red signal Sr′, the converted green signal Sg′ and the converted blue signal Sr′ are inputted to the column driver 2.

The column driver 2 applies a drive voltage or a drive current to a column electrode corresponding to a pixel to be driven, among the column electrodes in the display panel 5, on the basis of the inputted converted red signal Sr′, converted green signal Sg′ and converted blue signal Sr′, under the control of the control circuit 4.

On one hand, the row driver 3 selectively scans the respective row electrodes in the display panel 5 at a constant drive voltage or drive current for a constant period, under the control of the control circuit 4.

Then, a pixel on a point, where the row electrode to which the constant drive voltage or drive current is selectively applied and the column electrode to which the constant drive voltage or drive current is selectively applied on the basis of the converted red signal Sr′, the converted green signal Sg′ and the converted blue signal Sb′ cross each other, emits light on the basis of the drive voltage or the drive current in each signal at a timing when the converted red signal Sr′, the converted green signal Sg′ and the converted blue signal Sb′ are inputted.

At this time, the control circuit 4 outputs the matrix coefficient signal Sm to the matrix calculating circuit 1 and also controls a whole display apparatus 100.

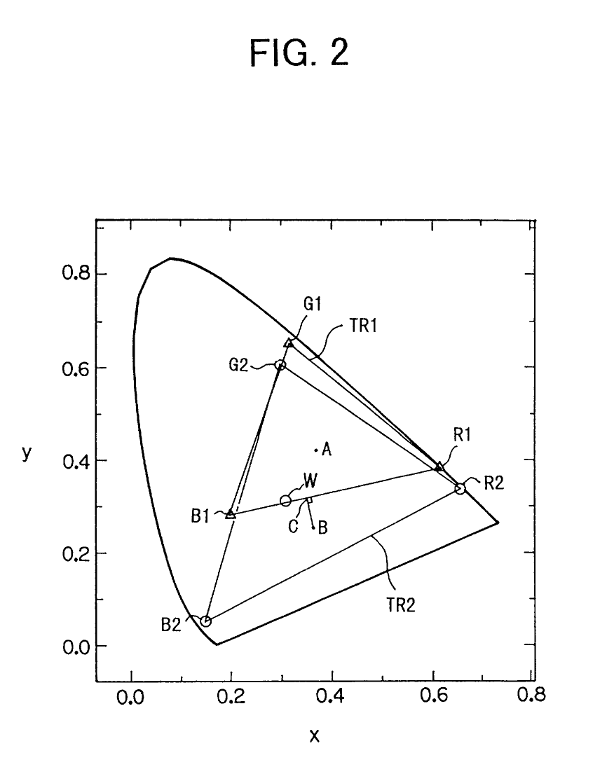

Operations of the matrix calculating circuit 1 and the control circuit 4 according to the present invention will be explained with reference to FIGS. 1 and 2.

At first, the difference between the coloring characteristics in the chromaticity diagram of the display panel 5 and a typical CRT is explained with reference to FIG. 2.

In FIG. 2, there are a chromaticity triangle TR1 (a triangle generated by joining points R1, G1 and B1 in FIG. 2) and a chromaticity triangle TR2 (a triangle generated by joining points R2, G2 and B2 in FIG. 2) on the chromaticity diagram. The chromaticity triangle represent a color range of an organic EL display, i.e., the display panel 5. The chromaticity triangle represent a color range of the CRT. On the chromaticity diagram, the form of the chromaticity triangle TR1 of the organic EL display is different from that of the chromaticity triangle TR2 of the CRT. If the same NTSC signal is inputted, the organic EL display is displayed which has, as a whole, a deeper green than that of the CRT.

At this time, as for the chromaticity coordinates at the respective vertexes R1, G1 and B1 in the chromaticity triangle TR1 of the organic EL display, as an example, the R1 is expressed as follows:

(X_{R}, Y_{R})=(0.5935, 0.3998). (1)

The G1 is expressed as follows:

(X_{G}, Y_{G})=(0.2853, 0.6696). (2)

The B1 is expressed as follows:

(X_{B}, Y_{B})=(0.1411, 0.2366). (3)

Moreover, the chromaticity coordinates of a white (W) servicing as a reference to set the respective luminances of the three primary colors are expressed as follows:

(X_{W}, Y_{W})=(0.3100, 0.3160). (4)

Now, as for the respective luminances of the three primary colors, they are adjusted such that the white having the maxi mum luminance is displayed, and then the respective luminances of the three primary colors are respectively defined as [1] when the white has the maximum luminance.

On the other hand, as for the chromaticity coordinates at the respective vertexes (R2, G2 and B2) in the chromaticity triangle TR2 when the NTSC signal is inputted to the CRT, the R2 is expressed as follows:

(X_{R}, Y_{R})=(0.6700, 0.3300). (5)

The G2 is expressed as follows:

(X_{G}, Y_{G})=(0.2100, 0.7100). (6)

The B2 is expressed as follows:

(X_{B}, Y_{B})=(0.1400, 0.0800). (7)

Moreover, the chromaticity coordinates of the W are similar to the case of the organic EL display.

Thus, as can be seen from FIG. 2, the colors displayed with regard to the G and the R are not largely varied when the same NTSC signal is inputted to the organic EL display and the CRT. However, with regard to the B, it is displayed as a perfectly different color. From the point of view, in this embodiment, a matrix conversion (chromaticity coordinates transformation) described below is performed for the data red signal Sr, the data green signal Sg and the data blue signal Sb generated by analyzing the NTSC signal inputted from the exterior for each color, in order to drive the display panel 5.

At first, in order to transiently convert the respective three primary colors R, G and B into tristimulus values X, Y and Z, a matrix M is defined as follows:

$$[ \begin{matrix}X \\ Y \\ Z\end{matrix} ] = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}R \\ G \\ B\end{matrix} ] \qquad ( 8 )$$

Now, the tristimulus values are explained. Any color can be made visually equal to the original color by mixing the three p primary colors by proper amounts (luminances) (this process is referred to as color matching). The tristimulus values represent these amounts of the respective three primary colors in the color matching.

On one hand, when the matrix M is defined as mentioned above, each of the respective tristimulus values and the chromaticity coordinates of the respective three primary colors have a relationship described below.

$$When [ \begin{matrix}R \\ G \\ B\end{matrix} ] = [ \begin{matrix}1 \\ 0 \\ 0\end{matrix} ] , X / ( X + Y + Z ) = {X}_{R} , Y / ( X + Y + Z ) = {Y}_{R} \\ When [ \begin{matrix}R \\ G \\ B\end{matrix} ] = [ \begin{matrix}0 \\ 1 \\ 0\end{matrix} ] , X / ( X + Y + Z ) = {X}_{G} , Y / ( X + Y + Z ) = {Y}_{G} \\ When [ \begin{matrix}R \\ G \\ B\end{matrix} ] = [ \begin{matrix}0 \\ 0 \\ 1\end{matrix} ] , X / ( X + Y + Z ) = {X}_{B} , Y / ( X + Y + Z ) = {Y}_{B} \\ When [ \begin{matrix}R \\ G \\ B\end{matrix} ] = [ \begin{matrix}1 \\ 1 \\ 1\end{matrix} ] , X / ( X + Y + Z ) = {X}_{W} , Y / ( X + Y + Z ) = {Y}_{W} \qquad ( 9 )$$

At this time, in order to give the standard of the luminance, the Y is defined as follows:

Y=1 (10)

Then, respective elements aᵢⱼ (i, j=1, 2, 3) in the matrix M are determined as follows:

a₁₁=(X_{R}/Y_{R})×a₂₁

a₁₂=(X_{G}/Y_{G})×a₂₂

a₁₃=(X_{B}/Y_{B})×a₂₃

a₂₁=Δ_{WGB}/Δ_{RGB}

a₂₂=Δ_{RWB}/Δ_{RGB}

a₂₃=Δ_{RGW}/Δ_{RGB}

a₃₁={(1−X_{R}−Y_{R})/Y_{R}}×a₂₁

a₃₂={(1−X_{G}−X_{G})/Y_{G}}×a₂₂

a₃₃={(1−X_{B}−Y_{B})/Y_{B}}×a₂₃. (11)

Δᵢⱼₖ (i, i, k=R, G, B, W) is given by the following equation.

Δᵢⱼₖ={Xᵢ(Yⱼ−Yₖ)+Xⱼ(Yₖ−Yᵢ)+Xₖ(Yᵢ−Yⱼ)}/YᵢYⱼYₖ (12)

Thus, the matrix M to convert the data red signal Sr, the data green signal Sg and the data blue signal Sb, which are obtained from the NTSC signal, into the tristimulus values X, Y and Z is expressed as the equation (13) by using the above mentioned coordinates (5) to (7) and the equations (11) and (12).

$$[ \begin{matrix}X \\ Y \\ Z\end{matrix} ] = {[ \begin{matrix}0.6070 & 0.1734 & 0.2006 \\ 0.2990 & 0.5864 & 0.1146 \\ 0.0000 & 0.0661 & 1.1175\end{matrix} ] [ \begin{matrix}R \\ G \\ B\end{matrix} ]}_{NTSC} \qquad ( 13 )$$

On the other hand, the matrix M to convert into the tristimulus values X, Y and Z the respective signals R, G and B by which the display panel 5 emits light is expressed as the equation (14) by using the above mentioned coordinates (1) to (3) and the equations (11) and (12).

$$[ \begin{matrix}X \\ Y \\ Z\end{matrix} ] = {[ \begin{matrix}0.6722 & 0.0438 & 0.2651 \\ 0.4528 & 0.1027 & 0.4445 \\ 0.0076 & 0.0069 & 1.1690\end{matrix} ] [ \begin{matrix}R \\ G \\ B\end{matrix} ]}_{EL} \qquad ( 14 )$$

Thus, it is enough that the right side of the equation (13) and the right side of the equation (14) are converted into the same tristimulus values, in order that the chromaticity coordinates are not varied when the display panel 5 is driven on the basis of the data red signal Sr, the data green signal Sg and the data blue signal Sb obtained from the NTSC signal. After all, it is sufficient that the right side of the equation (13) is made equal to the right side of the equation (14). Accordingly, the matrix M to respectively convert the data red signal Sr, the data green signal Sg and the data blue signal Sb, which are obtained from the NTSC signal, into the converted red signal Sr′, the converted green signal Sg′ and the converted blue signal Sb′ is expressed as follows:

$${[ \begin{matrix}X \\ Y \\ Z\end{matrix} ]}_{EL} = {[ \begin{matrix}1.0004 & - 0.1626 & 0.1622 \\ - 1.5096 & 6.3382 & - 3.8286 \\ 0.0024 & 0.0201 & 0.9775\end{matrix} ] [ \begin{matrix}R \\ G \\ B\end{matrix} ]}_{NTSC} \qquad ( 15 )$$

Hence, a coefficient of this matrix M is inputted as the matrix coefficient signal Sm from the control circuit 4 to the matrix calculating circuit 1. Then, the data red signal Sr, the data green signal Sg and the data blue signal Sb are respectively converted into the converted red signal Sr′, the converted green signal Sg′ and the converted blue signal Sb′ by the matrix calculating circuit 1. Accordingly, the display panel 5 is driven through the column driver 2.

This operation of the matrix calculating circuit 1 enables the color having the chromaticity coordinates defining a point located inside the chromaticity triangle TR1 corresponding to the organic EL display (for example, a color having the chromaticity coordinates defining a point denoted by a symbol “A” in FIG. 2) to be displayed on the display panel 5 without the variation of the chromaticity coordinates, namely, without the variation of the color, even if the NTSC signal is inputted to the display apparatus 100 while maintaining its original state.

Incidentally, as for a particular color which has the chromaticity coordinates defining a point located outside the chromaticity triangle TR1 corresponding to the organic EL display and located inside the chromaticity triangle TR2 corresponding to the CRT (for example, a color having the chromaticity coordinates defining a point denoted by a symbol “B” in FIG. 2), an analogous color having chromaticity coordinates defining a point located inside the chromaticity triangle TR1 corresponding to the organic EL display and located close to the point B defined by the chromaticity coordinates of the particular color is displayed on the display panel 5 instead of the particular color.

There are a number of methods to decide the color having chromaticity coordinates defining a point inside the chromaticity triangle TR1 corresponding to the organic EL display and located close to the point B defined by the chromaticity coordinates of the particular color.

In a first method, first, one side of the chromaticity triangle TR1 corresponding to the organic EL display located at the closest position of the point B is selected. Next, the straight line perpendicular to the selected side of the chromaticity triangle TR1 is drawn from the point B. Thus, the point “C” that the straight line intersects the selected side of the chromaticity triangle TR1 is defined, and the color having the chromaticity coordinates corresponding to the point C is displayed on the display panel 5 instead of the particular color.

In a second method, for example, as shown in FIG. 2, when the point B defined by the chromaticity coordinates of the particular color are located on the lower side of a straight line the connecting the vertex R1 and the vertex B1 in the chromaticity triangle TR1, the point that the straight line connecting point B and the vertex G1 intersects the straight line connecting the vertex B1 and the vertex R1 is defined, and the color having the chromaticity coordinates corresponding to the defined point is displayed on the display panel 5 instead of the particular color.

In a third method, at least one of the data red signal Sr, the data green signal Sg and the data blue signal Sb which correspond to the particular color having the chromaticity coordinates corresponding to the point B is negative signal. This fact is used in the third method. Namely, in the third method, the negative signal is converted to “0”, and the other non-negative signals are adjusted depending on this conversion.

Concretely, in this third method, in case that the luminance is varied with the chromaticity coordinates transformation between point B and the point C, first, a negative signal is selected from among the data red signal Sr, the data green signal Sg and the data blue signal Sb which correspond to the particular color having the chromaticity coordinates corresponding to the point B, and second, the luminance component of the negative signal is subtracted from the non-negative signal so as to enable the luminances before and after the transformation to be constant. For example, when the luminance values of the converted red signal Sr′, the converted green signal Sg′ and the converted blue signal Sb′ are respectively “3”, “−1” and “2”, the respective luminance values (Sr″, Sg″ and Sb″) at the point C after the transformation are calculated as follows:

Sr″=3+3/(3+2)×Sg′

Sg″=0

Sb″=3+2/(3+2)×Sg′. (16)

Thus, the luminances before and after the conversion can be made constant.

Incidentally, the chromaticity coordinates transformation between the point B and the point C is performed by the matrix calculating circuit 1.

As explained above, according to the display apparatus 100 in the embodiment, the data red signal Sr, the data green signal Sg and the data blue signal Sb which correspond to the CRT are converted into the converted red signal Sr′, the converted green signal Sg′ and the converted blue signal Sb′ which correspond to the display panel 5. Thus, even if the data red signal Sr, the data green signal Sg and the data blue signal Sb which do not correspond to the display panel 5 are inputted, it is possible to reduce the color difference and improve the color reproducibility.

The respective luminances in the data red signal Sr, the data green signal Sg and the data blue signal Sb are converted into the respective luminances in the converted red signal Sr′, the converted A green signal Sg′ and the converted blue signal Sb′, respectively, by using the pre-set matrix M. Hence, it is possible to drive the display panel 5 without performing complex processes.

Moreover, as for the particular color which has the chromaticity coordinates defining a point located outside the chromaticity triangle TR1 corresponding to the organic EL display a and located inside the chromaticity triangle TR2 corresponding to the CRT, a color having chromaticity coordinates defining a point located inside the chromaticity triangle TR1 corresponding to the organic EL display and located at the closet position to the point defined by the chromaticity coordinates of the particular color is displayed on the display panel 5 instead of the particular color. Hence, it is possible to display without largely reducing the color reproducibility.

Incidentally, the case in which the display panel 5 is driven on the basis of the NTSC signal generated for the CRT is explained in the above mentioned embodiment. In addition, the present invention can be applied to a case in which the display panel 5 is driven on the basis of a PAL (Phase Alternation by Line) method signal generated for the CRT or a case in which the display panel 5 is driven on the basis of an SECAM (Sequential of Memory) method signal generated for the CRT.

Moreover, the present invention can be applied to not only a display apparatus that is driven on the basis of a so-called composite signal, such as the above mentioned NTSC signal but also a display apparatus that is driven on the basis of image signals which are generated to be used in a computer and the like and are originally separated for each R, G and B.

Furthermore, the present invention can be applied to a case in which an image signal generated for a certain display apparatus is used for another display apparatus having a different lighting characteristics (e.g., a different chromaticity triangles) from the certain display apparatus, while maintaining its original state.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A display apparatus comprising:
an inputting device for inputting a first image signal generated for a first display device having a first coloring characteristic defined by a first color range shown in a chromaticity diagram;
a converting device for converting said inputted first image signal into a second image signal suitable for a second display device having a second coloring characteristic defined by a second color range shown in said chromaticity diagram, said second color range and said first color range are different from each other;
a driving device for generating a driving signal on the basis of said second image signal; and
said second display device for displaying an image on the basis of said driving signal.

2. A display apparatus according to claim 1, wherein said converting device converts said inputted first image signal into said second image signal by changing luminance of a red color generated by a red signal included in said first image signal, luminance of a green color generated by a green signal included in said first image signal, and luminance of a blue color generated by a blue signal included in said first image signal.

3. A display apparatus according to claim 1, wherein said converting device converts said inputted first image signal into said second image signal by performing a chromaticity coordinates transformation in said chromaticity diagram.

4. A display apparatus according to claim 1, wherein said converting device converts said inputted first image signal into said second image signal by using pre-set matrix data.

5. A display apparatus according to claim 1, wherein said first display device is a CRT (Cathode Ray Tube) display, and said second display device is an EL (Electro-Luminescence) display.

6. A display apparatus according to claim 1, wherein, when a particular color generated by said inputted first image signal has chromaticity coordinates defining a point located inside said first color range and located outside said second color range, said converting device converts said inputted first image signal into said second image signal so as to generate an analogous color having chromaticity coordinates defining a point located inside said second color range and located at a closest position to said point defined by said chromaticity coordinates of said particular color.
